(19) United States
(12) Patent Application Publication
(10) Pub. No.: US 2012/0264372 A1
(43) Pub. Date: Oct. 18, 2012

(54) METHOD FOR CONTROLLING WIRELESS PRINTING JOB AND PRINTER

(75) Inventors: Johnny Chen, Santa Ana, CA (US); Gary Kung, Santa Ana, CA (US)

(73) Assignee: I O INTERCONNECT, LTD.

(21) Appl. No.: 13/270,174

(22) Filed: Oct. 10, 2011

Related U.S. Application Data
(60) Provisional application No. 61/475,293, filed on Apr. 14, 2011.

(51) Int. Cl. H04B 5/00; G06K 15/00

(52) U.S. Cl. 455/41.1; 358/1.15

(57) ABSTRACT

A printer includes a memory module, a transceiver module, a processor and a print engine. The memory module stores one or more file(s). The transceiver module transmits information pertinent to the file(s) stored in the memory module to a peer electronic device and receives a print request carrying information pertinent to one or more file(s) selected to be printed from the peer electronic device. The processor obtains the information pertinent to the file(s) stored in the memory module and passes the information pertinent to the file(s) to the transceiver module, receives the print request from the transceiver module and processes the received print request, and issues a print command for printing the selected file(s) in response to the received print request. The print engine prints the selected file(s) in response to the print command.

### CROSS REFERENCE TO RELATED APPLICATIONS

This application claims the benefit of U.S. Provisional Application No. 61/475,293 filed Apr. 14, 2011 and entitled “A printing system and control method thereof”. The entire contents of which are hereby incorporated by reference.

### BACKGROUND OF THE INVENTION

1. Field of the Invention

The invention relates to a method for controlling a wireless printing job.

2. Description of the Related Art

As digital cameras become more widely used today, the demand for printing digital photos increases. Generally, digital photo data is stored in a memory card, which is inserted into a memory card slot of a digital camera. In a conventional method, when a digital camera user wants to print the digital photos, the memory card is removed from the digital camera and connected, for example, via a card reader, to a computer to print the digital photos using a printer connected to the computer. However, because a computer is required, it is inconvenient for the digital camera user.

Therefore, a novel printing system and method is highly required.

### BRIEF SUMMARY OF THE INVENTION

Printers and a method for controlling a wireless printing job are provided. An exemplary embodiment of a printer comprises a memory module, a transceiver module, a processor and a print engine. The memory module stores one or more file(s). The transceiver module transmits information pertinent to the file(s) stored in the memory module to a peer electronic device and receives a print request comprising information pertinent to one or more file(s) selected to be printed from the peer electronic device. The processor obtains the information pertinent to the file(s) stored in the memory module and passes the information pertinent to the file(s) to the transceiver module, receives the print request from the transceiver module and processes the received print request, and issues a print command for printing the selected file(s) in response to the received print request. The print engine prints the selected file(s) in response to the print command.

An exemplary embodiment of a method for controlling a wireless printing job comprises: sharing information pertinent to one or more file(s) stored in a memory module to one or more peer electronic device(s) by a printer; receiving a print request comprising information pertinent to one or more file(s) selected to be printed from one of the peer electronic device(s) by the printer; printing the selected file(s) in response to the print request by the printer.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a printing system according to an embodiment of the invention;

FIG. 2 shows a schematic block diagram of the printer according to an embodiment of the invention;

FIG. 3 shows a flow chart of a method for controlling a wireless printing job according to an embodiment of the invention; and

FIG. 4 shows a schematic block diagram of the printer according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

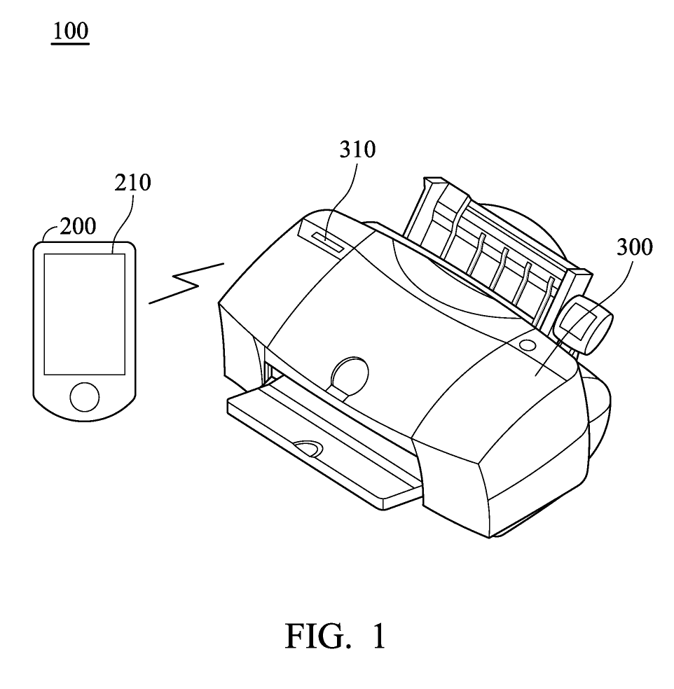

FIG. 1 shows a printing system according to an embodiment of the invention. According to an embodiment of the invention, the printing system 100 may comprise a printer 300 and one or more electronic devices, such as, a cell phone, a PDA, a tablet computer or others, residing within the reach of the signals transmitted by the printer. Note that in FIG. 1, a cell phone is shown as an exemplary electronic device 200. However, the invention should not be limited thereto. The electronic device 200 may wirelessly communicate with the printer 300 and control the printing operations thereof. The printer 300 may comprise one or more memory card slot 310, into which a memory card (i.e. a data provider) may be inserted.

According to an embodiment of the invention, a local network may be formed between the printer and the electronic device(s). In the embodiments of the invention, the local network may be a wireless local area network (wireless LAN), and the signals may be transmitted in the local network in compliance with an UPnP protocol, a WiFi protocol, a Bluetooth protocol, or the likes.

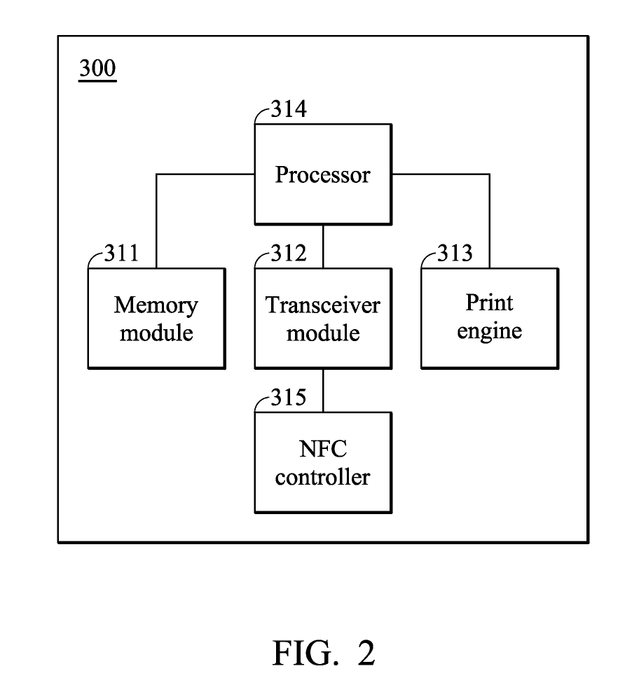

FIG. 2 shows a schematic block diagram of the printer 300 according to an embodiment of the invention. The printer 300 may at least comprise a memory module 311, a transceiver module 312, a print engine 313 and a processor 314 coupled to the memory module 311, the transceiver module 312 and the print engine 313 for controlling the operations thereof. In some embodiments, when an external memory card is inserted in the memory card slot 310 of the printer 300 as shown in FIG. 1, the external memory card may be regarded as a part of the memory module 311 of the printer 300.

According to the concept of the invention, information pertinent to one or more file(s) stored in the memory module may be shared by the printer 300 to one or more peer electronic device(s) (such as the electronic device 200) in the local network. The peer electronic device(s) receiving the information pertinent to the file(s) stored in the memory module may select one or more file(s) to be printed and transmit a print request comprising information pertinent to the selected file(s) to the printer 300. After receiving the print request, the printer 300 may print the selected file(s) in response to the print request.

To be more specific, in some embodiments of the invention, the processor 314 may first obtain information pertinent to the file(s) stored in the memory module and pass the information pertinent to the file(s) to the transceiver module 312. The transceiver module 312 may transmit information pertinent to the file(s) stored in the memory module to one or more peer electronic device(s) in the local network by broadcasting, multi-casting or uni-casting (which will be discussed in more detail in the following paragraphs). The transceiver module 312 may further receive the print request comprising information pertinent to one or more file(s) selected to be printed from the peer electronic device(s) and pass the received information to the processor 314. The processor 314 may process the received print request and issue a print command to the print engine 313 for printing the selected file(s) in response to the received print request. Finally, the print engine 313 may print the selected file(s) in response to the print command.

Note that in the embodiments of the invention, the information pertinent to the file(s) stored in the memory module transmitted by the printer 300 may comprise only file name(s) of the file(s), or may further comprise content of the file(s). Correspondingly, the information pertinent to the selected file(s) may comprise only file name(s) of the selected file(s), or further comprise content of the selected file(s). Several embodiments will be discussed in more detail in the following paragraphs.

According to a first embodiment of the invention, when the external memory card is inserted in the memory card slot 310, information pertinent to the file name(s) of the data (for example, images, documents or others) stored in the memory module 311 may be extracted by the processor 314 and transmitted by the transceiver module 312 to the electronic device 200. The transceiver module 312 may transmit the information by broadcasting the information to the air interface, multi-casting the information to a group of authorized electronic devices (for example, the electronic devices with a specific application installed therein), or uni-casting the information to the electronic device 200.

After receiving information pertinent to the file name(s) of the data stored in the memory module 311, the electronic device 200 user may select the data to be printed according to the file name(s), and transmit a print request comprising information pertinent to the selected file name(s) to be printed to the printer 300. When the transceiver module 312 receives the print request, the processor 314 may process the received print request and issue a print command to direct the print engine 313 to print the selected file(s).

According to a second embodiment of the invention, when the external memory card is inserted in the memory card slot 310, information pertinent to content of the data stored in the memory module 311 may be extracted by the processor 314 and transmitted by the transceiver module 312 to the electronic device 200. Similarly, the transceiver module 312 may transmit the information by broadcasting the information to the air interface, multi-casting the information to a group of authorized electronic devices (for example, the electronic devices with a specific application installed therein), or uni-casting the information to the electronic device 200.

After receiving information pertinent to the content of the data stored in the memory module 311, the electronic device 200 may show the content on a screen 210 of the electronic device 200 to facilitate a user of the electronic device 200 to select one or more file(s) to be printed, and transmit a print request comprising information pertinent to the one or more file(s) selected to be printed to the printer 300. To be more specific, the electronic device 200 user may preview the file(s)via the screen 210, select the file(s) (for example, images, documents or others) to be printed, and transmit a print request comprising information pertinent to the selected file(s) to the printer 300. Similarly, when the transceiver module 312 receives the print request comprising the information pertinent to the selected file(s), the processor 314 may issue a print command to direct the print engine 313 to print the selected file(s).

According to a third embodiment of the invention, when the external memory card is inserted in the memory card slot 310, information pertinent to file names of the data stored in the memory module 311 may be extracted by the processor 314 and transmitted by the transceiver module 312 to the electronic device 200. Similarly, the transceiver module 312 may transmit the information by broadcasting the information to the air interface, multi-casting the information to a group of authorized electronic devices (for example, the electronic devices with a specific application installed therein), or uni-casting the information to the electronic device 200.

After receiving information pertinent to file name(s) of the data stored in the memory module 311, the electronic device 200 user may select the file(s) he/she would like to preview (i.e. the interested file(s)), and transmit a preview request comprising information pertinent to the selected file(s) he/she would like to preview to the printer 300. After receiving the preview request comprising information pertinent to the selected file(s) that the electronic device 200 user would like to preview, the data content of the selected file(s) may be extracted by the processor 314 and transmitted by the transceiver module 312 to the electronic device 200.

When receiving the content of the selected file(s), the electronic device 200 may show the content of the file(s) on the screen 210 of the electronic device 200 for the user to preview the interested file(s). The electronic device 200 user may preview the content of the file(s) via the screen 210, select the file(s) (for example, images, documents or others) he/she would like to print, and transmit a print request comprising the information pertinent to the selected file(s) he/she would like to print to the printer 300. Similarly, when the transceiver module 312 receives the print request comprising the information pertinent to the selected file(s) that the electronic device 200 user would like to print, the processor 314 may issue a print command to direct the print engine 313 to print the selected file(s).

As previously described, the connection between the electronic device 200 and the printer 300 may be established in a wireless manner in compliance with an UPnP protocol, a WiFi protocol, a Bluetooth protocol, or the likes. Before establishing the connection, a near field communication may further be established for authentication and performance information exchange between the electronic device 200 and the printer 300. Referring back to FIG. 2, according to another embodiment of the invention, the printer 300 may further comprise a near field communication (NFC) controller 315, coupled to the transceiver module 312, for communicating another NFC enabled device in accordance with an NFC communication protocol. The NFC controller 315 may be an NFC chip, an NFC circuit, an NFC processor logic in accompanying with an antenna coil, or the likes.

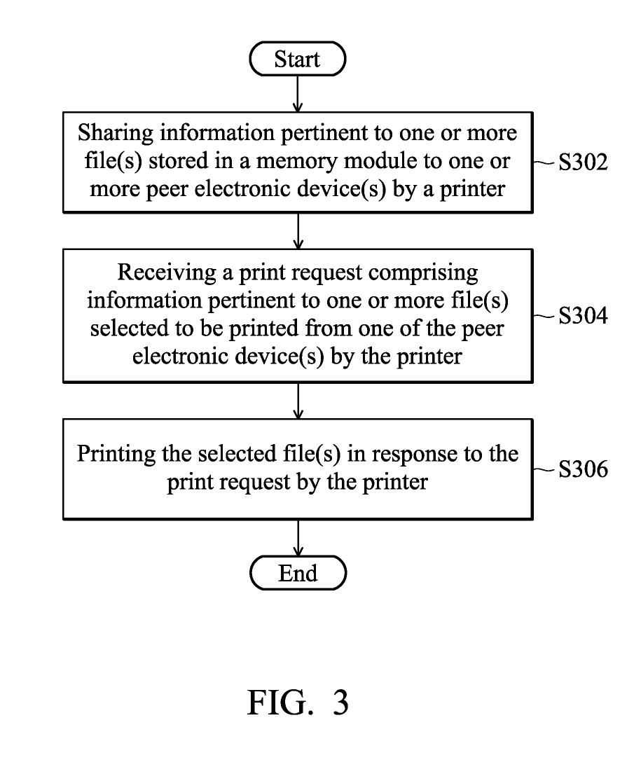

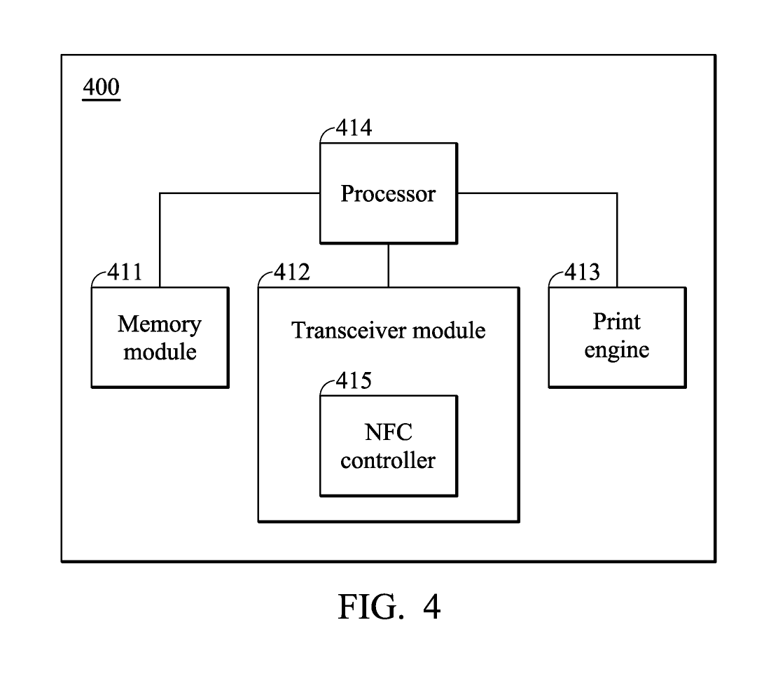

Note that in other embodiments of the invention, the NFC controller may also be comprised or integrated in the transceiver module, and the invention should not be limited to either cases. FIG. 4 shows a schematic block diagram of the printer according to another embodiment of the invention. The printer 400 may at least comprise a memory module 411, a transceiver module 412, a print engine 413 and a processor 414 coupled to the memory module 411, the transceiver module 412 and the print engine 413 for controlling the operations thereof. The NFC controller 415 is integrated in the transceiver module 412 and controlled by the transceiver module 412. Operations of the memory module 411, the transceiver module 412, the print engine 413, the processor 414 and the NFC controller 415 are similar to those as shown in FIG. 3. Therefore, reference may be made to the corresponding paragraphs, and detailed descriptions are omitted here for brevity.

The Near Field Communication or NFC is a short-range high frequency wireless communication technology which enables the exchange of data between devices over about a 10 centimeters (around 4 inches) distance. The technology is a simple extension of the ISO/IEC 14443 proximity-card standard (contactless card, RFID). As the electronic device 200 equipped with an NFC enabled tag or an NFC controller or the likes is positioned close enough to the printer 300, the printer 300 may detect its existence and establish the near field communication with the electronic device 200. Note that the establishment of near field communication may also be initiated or triggered by the electronic device 200, and the invention should not be limited thereto.

According to an embodiment of the invention, identity information of the electronic device 200 and/or the printer 300 may first be transmitted or exchanged therebetween via the near field communication for authentication. Note that the identity authentication may be implemented in various ways, and the invention is not limited to any specific method. For the reference may be made to the publications in the related art, detailed descriptions of the identity authentication method are omitted here for brevity. After completion of the identity authentication, information (for example, the directory, IP address, protocol messages or others) regarding establishment of the connection (as previously described, the UPnP, WiFi or Bluetooth connection, or others) between the electronic device 200 and the printer 300 may further be transmitted or exchanged therebetween via the near field communication. Having such information, the connection may be established for sharing the information pertinent to one or more file(s), transmitting/receiving the print request and/or transmitting/receiving content of the file(s) between the electronic device 200 and the printer 300 as previously described.

The proposed wireless printing control method is advantageous to the electronic devices that are not equipped with a memory card slot, such as the iPad or iPhone manufactured by the Apple computer incorporation. According to the proposed method, the printer 300 may act as a server and may have a predetermined directory, IP address, or the like. The electronic device 200 may connect to the printer 300 to directly access the file(s) stored in the memory card, or connect to the printer 300 to browse the file(s) stored in the memory card via the screen 210, or receive information regarding the file(s) stored in the memory card from the printer. The electronic device 200 user may also make a request for the file(s) he/she would like to be preview and preview the file(s) via the screen 210. The electronic device 200 user may further select the file(s) he/she would like to print, and direct the printer 300 to print the selected file(s).

FIG. 3 shows a flow chart of a method for controlling a wireless printing job according to an embodiment of the invention. The information pertinent to one or more file(s) stored in a memory module is first shared by the printer to one or more peer electronic device(s) (Step S302). Next, a print request comprising information pertinent to one or more file(s) selected to be printed is received by the printer from one of the peer electronic device(s) (Step S304). Finally, the selected file(s) is/are printed in response to the print request by the printer (Step S306).

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A printer, comprising:
a memory module, for storing one or more file(s);
a transceiver module, for transmitting information pertinent to the file(s) stored in the memory module to a peer electronic device and receiving a print request comprising information pertinent to one or more file(s) selected to be printed from the peer electronic device;
a processor, for obtaining the information pertinent to the file(s) stored in the memory module and passing the information pertinent to the file(s) to the transceiver module, receiving the print request from the transceiver module and processing the received print request, and issuing a print command for printing the selected file(s) in response to the received print request; and
a print engine, for printing the selected file(s) in response to the print command.

2. The printer as claimed in claim 1, further comprising:
a near field communication controller, coupled to the transceiver module, for communicating with the peer electronic device in accordance with an NFC communication protocol.

3. The printer as claimed in claim 1, wherein the transceiver module further comprises:
a near field communication controller, for communicating with the peer electronic device in accordance with an NFC communication protocol.

4. A method for controlling a wireless printing job, comprising:
sharing information pertinent to one or more file(s) stored in a memory module to one or more peer electronic device(s) by a printer;
receiving a print request comprising information pertinent to one or more file(s) selected to be printed from one of the peer electronic device(s) by the printer; and
printing the selected file(s) in response to the print request by the printer.

5. The method as claimed in claim 4, wherein the information pertinent to the file(s) stored in the memory module is shared to the peer electronic device(s) by broadcasting or multi-casting the information within a local network.

6. The method as claimed in claim 4, wherein the information pertinent to the file(s) stored in the memory module is shared to the peer electronic device(s) by uni-casting the information to each peer electronic device(s).

7. The method as claimed in claim 4, wherein the information pertinent to the file(s) stored in the memory module comprises only file name(s) of the file(s).

8. The method as claimed in claim 7, further comprising:
receiving a preview request comprising information pertinent to one or more file(s) selected to be previewed from the peer electronic device by the printer;
transmitting content of the file(s) selected to be previewed to the peer electronic device by the printer in response to the preview request.

9. The method as claimed in claim 8, further comprising:
showing the content of the file(s) selected to be previewed on a screen of the peer electronic device to facilitate a user of the peer electronic device to preview and select the one or more file(s) to be printed after receiving the content from the printer; and
transmitting the print request comprising information pertinent to the one or more file(s) selected to be printed from the peer electronic device to the printer.

10. The method as claimed in claim 4, wherein the information pertinent to the file(s) stored in the memory module comprises content of the file(s).

11. The method as claimed in claim 10, further comprising:
showing the content of the file(s) stored in the memory module on a screen of the peer electronic device to facilitate a user of the peer electronic device to select the one or more file(s) to be printed after receiving the information pertinent to the one or more file(s) shared by the printer; and
transmitting the print request comprising information pertinent to the one or more file(s) selected to be printed from the peer electronic device to the printer.

12. The method as claimed in claim 4, wherein the information pertinent to the selected file(s) comprises only file name(s) of the selected file(s).

13. The method as claimed in claim 4, wherein the information pertinent to the selected file(s) comprises content of the selected file(s).

14. The method as claimed in claim 4, further comprising:
establishing a near field communication in a contactless manner between the peer electronic device(s) and the printer before sharing the information pertinent to one or more file(s).

15. The method as claimed in claim 14, further comprising:
transmitting identity information of the peer electronic device(s) and/or the printer via the near field communication for authentication.

16. The method as claimed in claim 14, further comprising:
transmitting information regarding establishment of a connection between the peer electronic device(s) and the printer via the near field communication to facilitate establishing a connection for sharing the information pertinent to one or more file(s).

17. The method as claimed in claim 14, further comprising:
transmitting information regarding establishment of a connection between the peer electronic device(s) and the printer via the near field communication to facilitate establishing a connection for receiving the print request.
